(19) United States
(12) Patent Application Publication
(10) Pub. No.: US 2025/0180384 A1
(43) Pub. Date: Jun. 5, 2025

(54) MODE EXCITATION DETECTION FOR A VIBRATORY FLOWMETER AND RELATED METHODS

(71) Applicant: MICRO MOTION, INC., Boulder, CO (US)

(72) Inventors: Marc Allan BUTTLER, Erie, CO (US); Andrew Timothy PATTEN, Gunnison, CO (US)

(73) Assignee: MICRO MOTION, INC., Boulder, CO (US)

(21) Appl. No.: 18/845,227

(22) PCT Filed: Mar. 28, 2022
(86) PCT No.: PCT/US2022/022103

§ 371 Date: Sep. 9, 2024

(51) Int. Cl. G01F 1/84; G08B 21/18

(52) U.S. Cl. CPC G01F 1/8427; G01F 1/8422; G01F 1/8436; G08B 21/182

(57) ABSTRACT

A flowmeter is provided that includes a sensor assembly (10) and a meter electronics (20). The flowmeter further has one or more flow tubes (130, 130′) and a drive mechanism (180) coupled to the flow tubes (130, 130′) and oriented to induce a drive mode vibration therein. A pair of pickoff sensors (170L, 170R) is coupled to the flow tubes (130, 130′), and is configured to measure a vibrational response induced by the drive mechanism (180). At least one strain gage (200A, 200B) is coupled to the sensor assembly (10), and configured to detect a strain in the sensor assembly (10). The meter electronics (20) is connected to the drive mechanism (180) and the strain gage (200A, 200B) in series. The meter electronics (20) is configured to detect frequencies at which changes in strain are occurring.

### FIELD OF THE INVENTION

The embodiments described below relate to vibrating meters, and more particularly, to improved vibrating flowmeters utilizing modal excitation detection.

### BACKGROUND

Vibrating conduit sensors, such as Coriolis mass flowmeters and vibrating densitometers, typically operate by detecting motion of a vibrating conduit that contains a flowing material. Properties associated with the material in the conduit, such as mass flow, density and the like, can be determined by processing measurement signals received from motion transducers associated with the conduit. The vibration modes of the vibrating material-filled system generally are affected by the combined mass, stiffness, and damping characteristics of the conduit and the material contained therein.

It is well known to use vibrating flowmeters to measure mass flow and other properties of materials flowing through a pipeline. For example, vibrating Coriolis flowmeters are disclosed in U.S. Pat. No. 4,491,025 issued to J. E. Smith, et al. of Jan. 1, 1985 and also Re. 31,450 to J. E. Smith of Nov. 29, 1983. These flowmeters have one or more fluid tubes. Each fluid tube configuration in a Coriolis mass flowmeter has a set of natural vibration modes, which may be of a simple bending, torsional, radial, lateral, or coupled type. Each fluid tube is driven to oscillate at resonance in one of these natural modes. The vibration modes are generally affected by the combined mass, stiffness, and damping characteristics of the containing fluid tube and the material contained therein, thus mass, stiffness, and damping are typically determined during an initial calibration of the flowmeter using well-known techniques. A common design vibrates two flow tubes in a single mode shape that can be described as the out-of-phase bending mode for those tubes. This mode is often referred to as the “drive” mode because it is the vibration mode that the drive coil of the meter intentionally excites.

Material flows into the flowmeter from a connected pipeline on the inlet side of the flowmeter. The material is then directed through the fluid tube or fluid tubes and exits the flowmeter to a pipeline connected on the outlet side.

A driver, such as a voice-coil style driver, applies a force to the one or more fluid tubes. The force causes the one or more fluid tubes to oscillate. When there is no material flowing through the flowmeter, all points along a fluid tube oscillate with an identical phase. As a material begins to flow through the fluid tubes, Coriolis accelerations cause each point along the fluid tubes to have a different phase with respect to other points along the fluid tubes. The phase on the inlet side of the fluid tube lags the driver, while the phase on the outlet side leads the driver. Sensors are placed at two different points on the fluid tube to produce sinusoidal signals representative of the motion of the fluid tube at the two points. A phase difference of the two signals received from the sensors is calculated in units of time.

The phase difference between the two sensor signals is proportional to the mass flow rate of the material flowing through the fluid tube or fluid tubes. The mass flow rate of the material is determined by multiplying the phase difference by a flow calibration factor. The flow calibration factor is dependent upon material properties and cross-sectional properties of the fluid tube. One of the major characteristics of the fluid tube that affects the flow calibration factor is the fluid tube's stiffness. Prior to installation of the flowmeter into a pipeline, the flow calibration factor is determined by a calibration process. In the calibration process, a fluid is passed through the fluid tube at a given flow rate and the proportion between the phase difference and the flow rate is calculated. The fluid tube's stiffness and damping characteristics are also determined during the calibration process as is generally known in the art.

One advantage of a Coriolis flowmeter is that the accuracy of the measured mass flow rate is largely not affected by wear of moving components in the flowmeter, as there are no moving components in the vibrating fluid tube. The flow rate is determined by multiplying the phase difference between two points on the fluid tube and the flow calibration factor. The only input is the sinusoidal signals from the sensors indicating the oscillation of two points on the fluid tube. The phase difference is calculated from the sinusoidal signals. Since the flow calibration factor is proportional to the material and cross-sectional properties of the fluid tube, the phase difference measurement and the flow calibration factor are not affected by wear of moving components in the flowmeter.

A typical Coriolis mass flowmeter includes one or more transducers (or pickoff sensors), which are typically employed in order to measure a vibrational response of the flow conduit or conduits, and are typically located at positions upstream and downstream of the driver. The pickoff sensors are connected to electronic instrumentation. The instrumentation receives signals from the two pickoff sensors and processes the signals in order to derive a mass flow rate measurement, among other things.

Vibration modes of different shapes and natural frequencies will always exist in any mechanical structure, and Coriolis meters are no exception. Under certain conditions, excitation of vibration modes other than the mode or modes that the meter is designed to excite is undesirable. Such undesirable modal excitation can interfere with the accurate measurement of the fluid flow through the meter. Undesirable mode excitation can also adversely affect the reliability and life of the meter.

The embodiments described below overcome these and other problems and an advance in the art is achieved. The embodiments described below provide a flowmeter that employs strain gages to detect when undesirable excitation of unintended modes of vibration is occurring, and is employed as a diagnostic tool, for both troubleshooting flow measurement performance problems and for protecting meters from damage.

### SUMMARY OF THE INVENTION

A flowmeter including a sensor assembly and a meter electronics is provided according to an embodiment. The flowmeter comprises one or more flow tubes, and a drive mechanism coupled to the one or more flow tubes and oriented to induce a drive mode vibration in the one or more flow tubes. A pair of pickoff sensors is coupled to the one or more flow tubes, and configured to measure a vibrational response of the flow tubes induced by the drive mechanism. At least one strain gage is coupled to the sensor assembly, wherein the at least one strain gage is configured to detect a strain in the sensor assembly. The meter electronics is connected to the drive mechanism and the at least one strain gage, and the drive mechanism and the at least one strain gage are connected in series. The meter electronics is configured to detect frequencies at which changes in strain are occurring.

A method for detecting mode excitation in a flowmeter having a sensor assembly and meter electronics is provided according to an embodiment. The method comprises vibrating at least one of the one or more flow tubes in a drive mode vibration with a drive mechanism and measuring a vibrational response of the flow tubes induced by the drive mechanism with a pair of pickoff sensors. At least one strain gage coupled to the sensor assembly is provided. The drive mechanism and the at least one strain gage are connected to the meter electronics, wherein the drive mechanism and the at least one strain gage are connected in series. A strain in the sensor assembly is detected with the at least one strain gage. Frequencies at which changes in strain are occurring are detected.

### Aspects

According to an aspect, a flowmeter including a sensor assembly and a meter electronics is provided that comprises one or more flow tubes, and a drive mechanism coupled to the one or more flow tubes and oriented to induce a drive mode vibration in the one or more flow tubes. A pair of pickoff sensors is coupled to the one or more flow tubes, and configured to measure a vibrational response of the flow tubes induced by the drive mechanism. At least one strain gage is coupled to the sensor assembly, wherein the at least one strain gage is configured to detect a strain in the sensor assembly. The meter electronics is connected to the drive mechanism and the at least one strain gage, and the drive mechanism and the at least one strain gage are connected in series. The meter electronics is configured to detect frequencies at which changes in strain are occurring.

Preferably, the meter electronics is configured to detect vibrations at non-drive-mode frequencies in the signals received from the at least one strain gage.

Preferably, the meter electronics is configured to generate at least one of an alarm and a notification when the vibrations at non-drive-mode frequencies detected are less than or equal to a predetermined proximity to the drive mode frequency.

Preferably, the meter electronics is configured to output diagnostic information when the vibrations at non-drive-mode frequencies detected are less than or equal to a predetermined proximity to the drive mode frequency and whether a separation between non-drive-mode frequencies and the drive mode frequencies remains stable or is varying, wherein if the separation between non-drive-mode frequencies and the drive mode frequencies remains stable, the diagnostic information comprises an instruction to calibrate a flowmeter zero.

Preferably, the meter electronics is configured to output diagnostic information when the vibrations at non-drive-mode frequencies detected are less than or equal to a predetermined proximity to the drive mode frequency and whether a separation between non-drive-mode frequencies and the drive mode frequencies remains stable or is varying, wherein if the separation between non-drive-mode frequencies and the drive mode frequencies is varying, the diagnostic information comprises an instruction to identify and eliminate a potential mounting and/or process condition change or changes that are responsible for frequency separation variability.

Preferably, the meter electronics is configured to generate at least one of an alarm and a notification when frequencies for a non-drive mode known to be associated with meter reliability issues is detected.

Preferably, the at least one strain gage is coupled to at least one of the one or more flow tubes.

Preferably, the at least one strain gage is coupled to a brace bar.

According to an aspect, a method for detecting mode excitation in a flowmeter having a sensor assembly and meter electronics is provided. The method comprises vibrating at least one of the one or more flow tubes in a drive mode vibration with a drive mechanism and measuring a vibrational response of the flow tubes induced by the drive mechanism with a pair of pickoff sensors. At least one strain gage coupled to the sensor assembly is provided. The drive mechanism and the at least one strain gage are connected to the meter electronics, wherein the drive mechanism and the at least one strain gage are connected in series. A strain in the sensor assembly is detected with the at least one strain gage. Frequencies at which changes in strain are occurring are detected.

Preferably, the meter electronics is configured to detect vibrations at non-drive-mode frequencies in the signals received from the at least one strain gage.

Preferably, the meter electronics is configured to generate at least one of an alarm and a notification when the vibrations at non-drive-mode frequencies detected are less than or equal to a predetermined proximity to the drive mode frequency.

Preferably, the method further comprises outputting, by the meter electronics, diagnostic information when the vibrations at non-drive-mode frequencies detected are less than or equal to a predetermined proximity to the drive mode frequency and whether a separation between non-drive-mode frequencies and the drive mode frequencies remains stable or is varying, wherein if the separation between non-drive-mode frequencies and the drive mode frequencies remains stable, the diagnostic information comprises an instruction to calibrate a flowmeter zero.

Preferably, the method further comprises outputting, by the meter electronics, diagnostic information when the vibrations at non-drive-mode frequencies detected are less than or equal to a predetermined proximity to the drive mode frequency and whether a separation between non-drive-mode frequencies and the drive mode frequencies remains stable or is varying, wherein if the separation between non-drive-mode frequencies and the drive mode frequencies is varying, the diagnostic information comprises an instruction to identify and eliminate a potential mounting and/or process condition change or changes that are responsible for frequency separation variability.

Preferably, the method further comprises generating, by the meter electronics, at least one of an alarm and a notification when frequencies for a non-drive mode known to be associated with meter reliability issues is detected.

Preferably, the method further comprises coupling the at least one strain gage to at least one of the one or more flow tubes.

Preferably, the method further comprises coupling the at least one strain gage to a brace bar.

### BRIEF DESCRIPTION OF THE DRAWINGS

The same reference number represents the same element on all drawings. The drawings are not necessarily to scale.

FIG. 1 illustrates a prior art flowmeter;

FIG. 2 illustrates an embodiment of a flowmeter; and

FIG. 3 is a diagram of meter electronics.

### DETAILED DESCRIPTION OF THE INVENTION

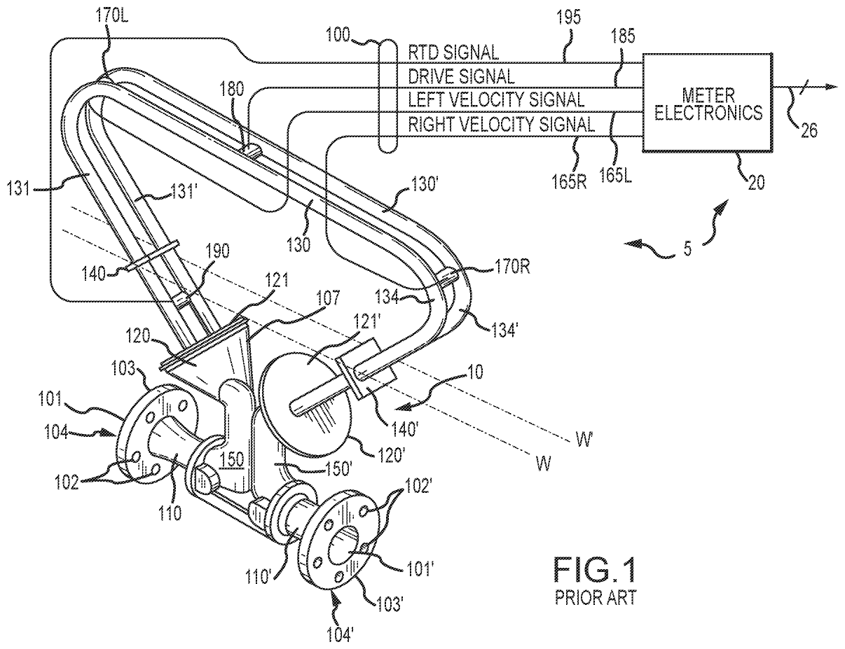

FIGS. 1-3 and the following description depict specific examples to teach those skilled in the art how to make and use the best mode of embodiments of a flowmeter and related methods. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 illustrates a prior art flowmeter 5, which can be any vibrating meter, such as a Coriolis flowmeter. The flowmeter 5 comprises a sensor assembly 10 and meter electronics 20. The sensor assembly 10 responds to mass flow rate and density of a process material. Meter electronics 20 are connected to the sensor assembly 10 via leads 100 to provide density, mass flow rate, and temperature information over path 26, as well as other information not relevant to the present invention. Sensor assembly 10 includes a pair of manifolds 150 and 150′, flanges 103 and 103′ having flange necks 110 and 110′, a pair of parallel flow tubes 130 (first flow tube) and 130′ (second flow tube), driver mechanism 180, temperature sensor 190 such as a resistive temperature detector (RTD), and a pair of pickoffs 170L and 170R, such as magnet/coil pickoffs, strain gages, optical sensors, or any other pickoff sensor known in the art. The flow tubes 130 and 130′ each have inlet legs 131 and 131′ and outlet legs 134 and 134′, which converge towards flow tube mounting blocks 120 and 120′. Flow tubes 130 and 130′ bend at least one symmetrical location along their length and are essentially parallel throughout their length. Brace bars 140 and 140′ serve to define the axis W and W′ about which each flow tube oscillates.

The side legs 131, 131′ and 134, 134′ of flow tubes 130 and 130′ are fixedly attached to flow tube mounting blocks 120 and 120′ and these blocks, in turn, are fixedly attached to manifolds 150 and 150′. This provides a continuous closed material path through the sensor assembly 10.

When flanges 103 and 103′, having bolt holes 102 and 102′ are connected, via inlet end 104 and outlet end 104′ into a process line (not shown) which carries the process material that is being measured, material enters end 104 of the meter through an orifice 101 in flange 103 and is conducted through manifold 150 to flow tube mounting block 120 having a surface 121. Within manifold 150 the material is divided and routed through flow tubes 130 and 130′. Upon exiting flow tubes 130 and 130′, the process material is recombined in a single stream within manifold 150′ and is thereafter routed to exit end 104′ connected by flange 103′ having bolt holes 102′ to the process line (not shown).

Flow tubes 130 and 130′ are selected and appropriately mounted to the flow tube mounting blocks 120 and 120′ so as to have substantially the same mass distribution, moments of inertia, and Young's modulus about bending axes W-W and W′-W′, respectively. These bending axes go through brace bars 140 and 140′. Inasmuch as the Young's modulus of the flow tubes change with temperature, and this change affects the calculation of flow and density, temperature sensor 190 is mounted to flow tube 130′, to continuously measure the temperature of the flow tube. The temperature of the flow tube and hence the voltage appearing across the temperature sensor 190 for a given current passing therethrough is governed by the temperature of the material passing through the flow tube. The temperature-dependent voltage appearing across the temperature sensor 190 is used in a well-known method by meter electronics 20 to compensate for the change in elastic modulus of flow tubes 130 and 130′ due to any changes in flow tube temperature. The temperature sensor 190 is connected to meter electronics 20 by lead 195.

Both flow tubes 130 and 130′ are driven by driver 180 in opposite directions about their respective bending axes W and W′ at what is termed the first out-of-phase bending mode of the flowmeter. This driver 180 may comprise any one of many well-known arrangements, such as a magnet mounted to flow tube 130′ and an opposing coil mounted to flow tube 130, through which an alternating current is passed for vibrating both flow tubes. A suitable drive signal is applied by meter electronics 20, via lead 185, to the driver 180.

Meter electronics 20 receive the temperature signal on lead 195, and the left and right velocity signals appearing on leads 165L and 165R, respectively. Meter electronics 20 produce the drive signal appearing on lead 185 to driver 180 and vibrate tubes 130 and 130′. Meter electronics 20 process the left and right velocity signals and the temperature signal to compute the mass flow rate and the density of the material passing through sensor assembly 10. This information, along with other information, is applied by meter electronics 20 over path 26 to utilization means.

Typically, Coriolis meters are driven at the first out-of-phase bend mode, with the flow-induced phase between inlet and outlet legs being sensed using coil/magnet pickoffs mounted on the inlet and outlet legs of the flowmeter. In an embodiment, combined signals from one or more strain gages attached to the internal vibrating structure of the meter are input into the meter electronics. Wheatstone bridge circuits may be used for amplifying the signals. In an embodiment, strain signals from the internal vibrating structure of the flowmeter are input into the meter electronics and processed to detect the natural frequencies of various multiple vibration mode shapes that are excited within the structure. The modal frequencies that are detected are analyzed to reveal diagnostic information for optimizing the installation and operation of the meter. In one embodiment, the signals from the one or more strain gages are transported superimposed onto other signals carried by existing signal conductors. By transmitting the strain gage signals via signal conductors that already exist in the extant flowmeter designs, this embodiment can be implemented and retrofitted on existing meter designs with greater ease.

For clarity, the number of conductors shown has been minimized. Although only a single line is drawn for 26, 165L, 165R, 185, and 195, this single line may represent one or more conductors. The driver circuit utilizing lead 185 is illustrated in more detail than other circuits to visually convey the series nature thereof. Other circuits present may be in series, parallel, or combinations thereof, whether specifically illustrated or not.

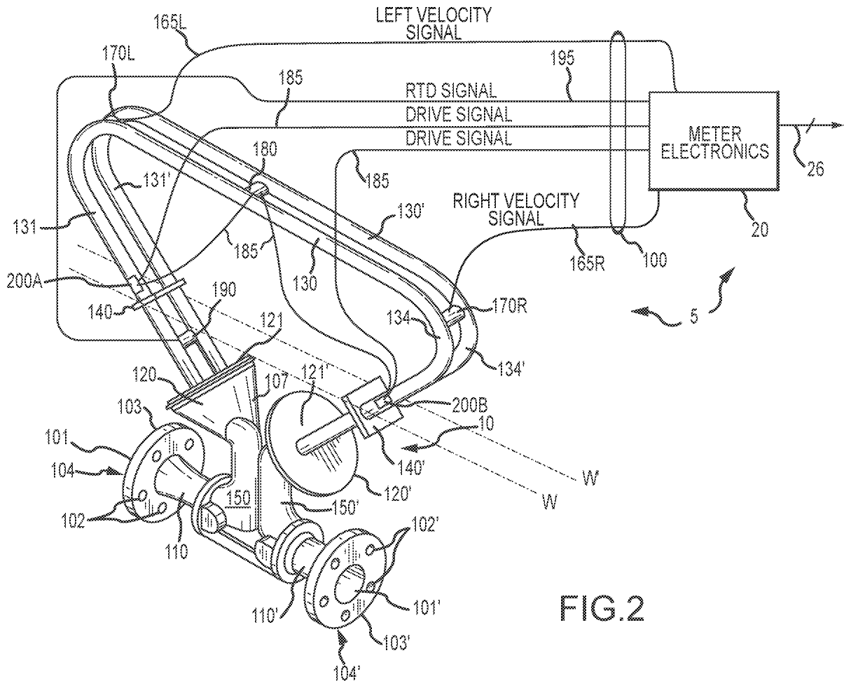

FIG. 2 illustrates an embodiment of a flowmeter 5. A Coriolis flowmeter structure is described although it is apparent to those skilled in the art that the present invention could be practiced as a vibrating tube densitometer without the additional measurement capability provided by a Coriolis mass flowmeter. Common elements with the prior art device of FIG. 1 share the same reference numbers. The flow tubes 130 and 130′ are driven by driver 180 in opposite directions about their respective bending axes W and W′ and at what is termed the first out-of-phase bending mode of the flowmeter. This driver 180 may comprise any one of many well-known arrangements, such as a magnet mounted to flow tube 130′ and an opposing coil mounted to flow tube 130 and through which an alternating current is passed for vibrating both flow tubes. It should be noted that the flow tubes 130, 130′ are substantially rigid—made from a metal, for example—such that they are capable of only limited motion, such as, for example, the vibratory motion induced by a driver. A suitable drive signal is applied by meter electronics 20, via lead 185, to the driver 180. A pair of pickoffs 170L and 170R, such as magnet/coil pickoffs, strain gages, optical sensors, or any other pickoff sensor known in the art is provided.

A first strain gage 200A and second strain gage 200B are provided. As illustrated, the first strain gage 200A is located on inlet leg 131 of the first flow tube 130 and the second strain gage 200B is located on the outlet leg 134 of the first flow tube 130. Strain gages may be on both flow tubes 130, 130′ in embodiments. Maximum strain amplitude is proximate the flow tube's 130, 130′ brace bar 140, 140′, and in an embodiment, this is where the strain gages 200A, 200B are located. However, other locations on the flow tubes are contemplated. Furthermore, placement on supporting structures, such as brace bars 140, 140′ are also contemplated. Overall, the strain element(s) are attached to the flow tube(s) and/or other part(s) of the meter structure that experience strain when the meter is vibrating in one or more undesirable mode shapes.

As illustrated the strain gages 200A, 200B are connected in series in the driver 180 circuit. This confers the advantage of being able to deliver signal from these strain gage elements to the Coriolis transmitter without requiring any change to the number of conductors in an existing meter feedthrough design or the transmitter connection, the elements would be connected in series with each other and also in series with the existing drive coil circuit. By using the drive coil circuit, the PO coil signals that are critical to the flow and density measurements made by the meter are left intact. In the illustrated series connection, the driver is disposed between the two strain gages 200A, 200B. It is also contemplated that the driver be the first element in the circuit, and the last element in the circuit, with regard to current flow.

In an embodiment, each strain gage is oriented to detect strain that is induced by a flow tube's 130, 130′ drive mode motion. In an embodiment, the strain gages 200A, 200B are oriented substantially parallel to a longitudinal axis of the flow tube to which that strain gage is coupled. Perpendicular orientations and non-orthogonal orientations are also contemplated.

Changes in resistance of the strain gages 200A, 200B are caused by the strain in the underlying surfaces to which they are attached. The magnitude of the changes in resistance do not need to necessarily be measured accurately in order for the embodiments to function as intended. It is the frequency at which the changes in strain are occurring that is particularly relevant, and this can be obtained without necessarily accurately measuring the magnitude of the resistance or the strain.

The most likely adverse effect on flow measurement due to undesirable mode excitation will manifest as meter zero shift or instability. The phase relationship between the signals from the pickoffs 170L and 170R indicate the amount of flow passing through the meter. The measured value of this phase difference, which corresponds to a zero-fluid-flow condition in the meter, is captured when the meter zero offset value is calibrated. This zero-offset value is subtracted from future flow measurements made by the meter to make the accuracy of those flow rate measurements more accurate.

However, the true meter zero offset phase difference can be shifted away from the originally calibrated value or can become unstable if mounting conditions change from those where the meter was calibrated. Furthermore, different fluid properties can cause undesirable mode shape frequencies to move close together to the drive mode frequency. If the natural frequencies of different mode shapes align too closely with the drive mode frequency, this can result in the drive coil exciting vibration in these other modes and interference between these modes and the drive mode may destabilize the meter zero offset value or shift it away from the previously calibrated value.

When meter zero is affected in this way, the resolution of this issue may require different actions depending on whether the relative separation of these frequencies is stable or variable. In the case where the amount of separation remains stable, simply recalibrating the zero value to the new condition may resolve any flow measurement issue. In the case where the separation in frequencies is not stable because one or more of the frequencies is constantly changing relative to the frequency of the drive mode in response to changing conditions, the solution is more likely going to require a change to the installation and/or operating conditions.

Detection and trending of the amount of separation between the drive mode frequency and any nearby mode frequencies can inform one whether to calibrate the meter zero in situ to resolve the issue if the mode separation is holding constant, or to instead investigate further to find out which mounting and/or process conditions are causing instability, in the case where the mode separation is varying. In the latter case, the capability of the meter to detect and trend the amount of mode separation would be useful in further diagnosing through trial and error which specific mounting and/or process condition changes do result in mode separation changes, and therefore zero instability.

Alternatively, there may exist some mode shapes that do not occur at frequencies that are close enough to the drive frequency to pose a risk to meter zero integrity, but nevertheless could amount to a risk to the mechanical reliability of the meter structure if they are excited by external forces to extreme levels. If undesirable excitation of these modes could also be detected, a potential future failure of the meter could be averted through preventative maintenance or adjustments to the installation or process conditions that are causing the undesirable mode excitation.

It is not possible to detect excitation of some or all of the undesirable modes in many Coriolis meters with the pickoff coils because these are typically designed and arranged for the purpose of optimizing measurement of the vibration of the meter tubes in the primary drive mode in order to achieve optimal flow and density measurement performance of the meter. As such, vibration in other modes may not generate sufficient contribution to the signal in the pickoff coils to be detectable. In mode shapes where the flow tubes vibrate directionally in-phase with each other, there is little or no relative motion created between the PO coils and magnets, and therefore no corresponding addition to the signal at the frequency of that mode. In mode shapes where the main movement of the flow tubes is in a direction that is lateral or orthogonal to the direction the tubes move in the drive mode, there is also likely to be little or no motion between the pickoff coils and magnets that are in the correct direction to generate signal in the frequency of that mode. The same is true of the drive coil and magnet, as they are typically arranged.

The strain gages 200A, 200B are thus used to detect structural vibrations at the frequencies of any undesirable modes of interest (i.e. non-drive-mode vibrations). The meter electronics 20 can do this by applying well established digital signal processing (DSP) techniques to transform either the dynamic resistance measurement of the circuit and/or dynamic changes in the drive current into the frequency domain. Once a signal has been processed to identify all frequencies that are superimposed on top of the drive coil circuit signal, the frequencies of mode shapes other than the drive mode are revealed. Any detected resistance and/or current changes that occur at these other frequencies would be the result of the strain that changes the resistance of the element(s) as these other modes are excited.

For any particular flowmeter model, the full range of frequencies that can occur as fluid properties and mounting conditions change can be predicted in advance with computer modeling for each of the modes that are known to potentially impact the meter accuracy or reliability. Any mode vibrations detected using this method can thus identify activity of a particular mode shape by checking the observed frequencies for a match against the known potential frequency range for the mode.

If the potential frequency range of a particular mode is known to be close enough or overlapping in frequency with the drive mode, this mode has the potential to impact meter zero stability because it will likely be more subject to frequency changes as the mounting conditions change, as compared to the drive mode. When the frequencies observed for these modes become too close to the drive frequency, this is an indicator that the undesirable mode is being excited by the same energy delivered by the drive coil to excite the drive mode. This phenomenon is very likely to cause zero stability problems in the meter because the cumulative motion of both modes combined will be constantly changing as mounting conditions change, thus affecting the stability of the meter zero. In an embodiment, the meter electronics 20 generates an alarm and/or notification when the frequencies observed for these modes are equal to or less than a predetermined proximity to the drive frequency.

By observing and trending the difference between the live frequency of the drive mode and the live frequency of a nearby mode, it is possible to detect when the mode frequencies may come too close together or even cross over on a regular basis. This observation provides a clear indication of modal interference as the root cause of any observed meter zero stability and accuracy problems. It will be understood that a threshold may be set with the meter electronics that, when crossed, indicates that the mode frequencies are too close together.

Similarly, if a particular mode when excited is known to be associated with meter reliability issues, detection of a frequency in the range of the known frequencies for that mode would be an indication that the mode is being excited by external vibration or by energy entering the meter structure from some other source. Since this mode is not intended to be active, any indication of a frequency appearing in the known range of frequencies for this mode would be a valuable diagnostic indicator that could guide measures to adjust the installation to eliminate the excitation of this mode.

In an embodiment, diagnostic information instructing operators on the most suitable remedies for certain undesirable mode excitations may be output by meter electronics. This is based upon the measured information of the frequency of the signal disturbance detected, which mode shape that frequency signifies, and the potential consequences of the excitation of that mode shape. Modes that can create problems will fall into two main categories:
1) The mode is too close in frequency to the drive frequency due to fluid density, mount conditions, etc. (in-phase modes that could interfere with zero stability);
2) The mode is potentially harmful to the meter and is being excited externally (e.g., lateral modes that could damage the meter if excited severely enough).

When the mode shape is a risk to zero stability because it is close in frequency to the drive frequency, the separation between the frequency of this mode and the drive mode can be monitored and the diagnostic instruction delivered will be based on whether the separation in frequencies remains stable or is varying. If the separation in frequencies remains stable, the instruction is to calibrate the zero. In an embodiment, the meter electronics 20 may automatically calibrate the zero when flow conditions are appropriate for a zero calibration. In another embodiment, the meter electronics 20 may prompt a user to calibrate the zero. If the separation in frequencies is varying, the instruction provided by meter electronics 20 is to identify and eliminate the mounting and/or process condition changes that are causing the frequency separation variability.

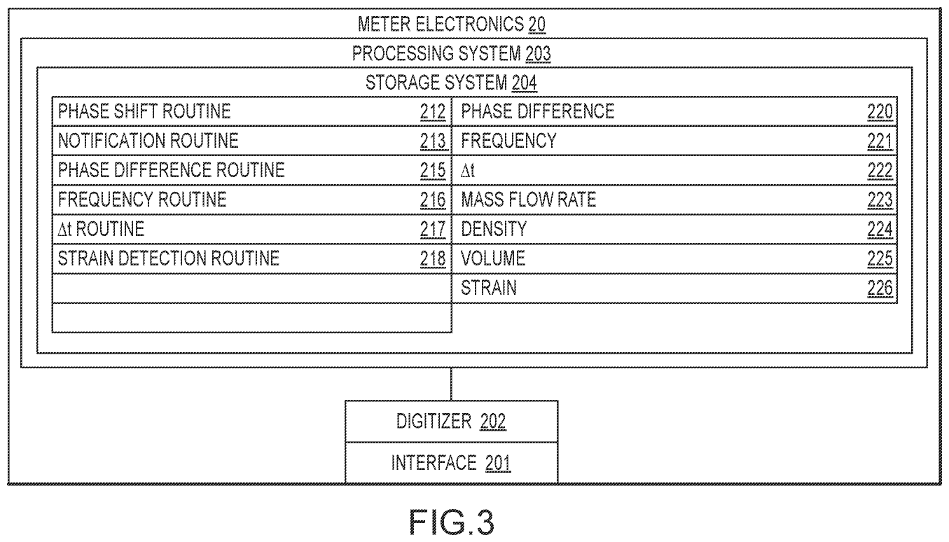

FIG. 3 illustrates meter electronics 20 of the flowmeter 5 according to an embodiment of the invention. The meter electronics 20 can include an interface 201 and a processing system 203. The meter electronics 20 receives first and second sensor signals from the sensor assembly 10, such as strain gage 200A, 200B signals, for example. The meter electronics 20 processes the first and second sensor signals in order to obtain flow characteristics of the flow material flowing through the sensor assembly 10. For example, the meter electronics 20 can determine one or more of a phase difference, a frequency, a time difference (Δt), a density, a mass flow rate, a strain, and a volume flow rate from the sensor signals, for example. In addition, other flow characteristics can be determined according to the invention.

The interface 201 receives strain gage signals via the leads utilized for the drive signal. Any strain gages 200A, 200B and driver(s) 180 are connected in series. The interface 201 can perform any necessary or desired signal conditioning, such as any manner of formatting, amplification, buffering, etc. Alternatively, some or all of the signal conditioning can be performed in the processing system 203. As noted, the meter electronics may apply well-established digital signal processing (DSP) techniques to transform either the dynamic resistance measurement of the circuit and/or dynamic changes in the drive current into the frequency domain.

In addition, the interface 201 can enable communications between the meter electronics 20 and external devices, such as through the communication path 26, for example. The interface 201 can be capable of any manner of electronic, optical, or wireless communication.

The interface 201 in one embodiment includes a digitizer 202, wherein the sensor signal comprises an analog sensor signal. The digitizer samples and digitizes the analog sensor signal and produces a digital sensor signal. The interface/digitizer can also perform any needed decimation, wherein the digital sensor signal is decimated in order to reduce the amount of signal processing needed and to reduce the processing time.

The processing system 203 conducts operations of the meter electronics 20 and processes flow measurements from the sensor assembly 10. The processing system 203 executes one or more processing routines and thereby processes the flow measurements in order to produce one or more flow characteristics.

The processing system 203 can comprise a general purpose computer, a microprocessing system, a logic circuit, or some other general purpose or customized processing device. The processing system 203 can be distributed among multiple processing devices. The processing system 203 can include any manner of integral or independent electronic storage medium, such as the storage system 204.

In the embodiment shown, the processing system 203 determines the vibration mode frequency characteristics from two or more vibrational/strain responses 220, 226. The processing system 203 can determine at least a magnitude, phase difference, time difference, and a frequency of the two or more responses 220, 226.

The storage system 204 can store flowmeter parameters and data, software routines, constant values, and variable values. In one embodiment, the storage system 204 includes routines that are executed by the processing system 203. In one embodiment, the storage system 204 stores a phase shift routine 212, a notification routine 213, a phase difference routine 215, a frequency routine 216, a time difference (Δt) routine 217, and a strain detection routine 218. In some embodiments, the storage system 204 stores one or more flow characteristics obtained from the flow measurements.

Bridge circuits may be used in these embodiments for amplifying a strain signal. In other embodiments, however, strain signals are utilized without any bridge circuitry.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein can be applied to other devices and methods, and not just to the embodiments described above and shown in the accompanying figures. Accordingly, the scope of the invention should be determined from the following claims.

What is claimed is:

1. A flowmeter (5) including a sensor assembly (10) and a meter electronics (20), comprising:
one or more flow tubes (130, 130′);
a drive mechanism (180) coupled to the one or more flow tubes (130, 130′) and oriented to induce a drive mode vibration in the one or more flow tubes (130, 130′);
a pair of pickoff sensors (170L, 170R) coupled to the one or more flow tubes (130, 130′), and configured to measure a vibrational response of the flow tubes (130, 130′) induced by the drive mechanism (180);
at least one strain gage (200A, 200B) coupled to the sensor assembly (10), wherein the at least one strain gage (200A, 200B) is configured to detect a strain in the sensor assembly (10);
wherein the meter electronics (20) is connected to the drive mechanism (180) and the at least one strain gage (200A, 200B), and the drive mechanism (180) and the at least one strain gage (200A, 200B) are connected in series; and
wherein the meter electronics (20) is configured to detect frequencies at which changes in strain are occurring.

2. The flowmeter (5) of claim 1, wherein the meter electronics (20) is configured to detect vibrations at non-drive-mode frequencies in the signals received from the at least one strain gage (200A, 200B).

3. The flowmeter (5) of claim 2, wherein the meter electronics (20) is configured to generate at least one of an alarm and a notification when the vibrations at non-drive-mode frequencies detected are less than or equal to a predetermined proximity to the drive mode frequency.

4. The flowmeter (5) of claim 2, wherein the meter electronics (20) is configured to output diagnostic information when the vibrations at non-drive-mode frequencies detected are less than or equal to a predetermined proximity to the drive mode frequency and whether a separation between non-drive-mode frequencies and the drive mode frequencies remains stable or is varying, wherein if the separation between non-drive-mode frequencies and the drive mode frequencies remains stable, the diagnostic information comprises an instruction to calibrate a flowmeter zero.

5. The flowmeter (5) of claim 2, wherein the meter electronics (20) is configured to output diagnostic information when the vibrations at non-drive-mode frequencies detected are less than or equal to a predetermined proximity to the drive mode frequency and whether a separation between non-drive-mode frequencies and the drive mode frequencies remains stable or is varying, wherein if the separation between non-drive-mode frequencies and the drive mode frequencies is varying, the diagnostic information comprises an instruction to identify and eliminate a potential mounting and/or process condition change or changes that are responsible for frequency separation variability.

6. The flowmeter (5) of claim 2, wherein the meter electronics (20) is configured to generate at least one of an alarm and a notification when frequencies for a non-drive mode known to be associated with meter reliability issues is detected.

7. The flowmeter (5) of claim 1, wherein the at least one strain gage (200A, 200B) is coupled to at least one of the one or more flow tubes (130, 130′).

8. The flowmeter (5) of claim 1, wherein the at least one strain gage (200A, 200B) is coupled to a brace bar (140, 140′).

9. A method for detecting mode excitation in a flowmeter having a sensor assembly and meter electronics, comprising the steps of:
vibrating at least one of the one or more flow tubes in a drive mode vibration with a drive mechanism;
measuring a vibrational response of the flow tubes induced by the drive mechanism with a pair of pickoff sensors;
providing at least one strain gage coupled to the sensor assembly;
connecting the drive mechanism and the at least one strain gage to the meter electronics, wherein the drive mechanism and the at least one strain gage are connected in series;
detecting a strain in the sensor assembly with the at least one strain gage;
detecting frequencies at which changes in strain are occurring.

10. The method of claim 9, wherein the meter electronics is configured to detect vibrations at non-drive-mode frequencies in the signals received from the at least one strain gage.

11. The method of claim 10, wherein the meter electronics is configured to generate at least one of an alarm and a notification when the vibrations at non-drive-mode frequencies detected are less than or equal to a predetermined proximity to the drive mode frequency.

12. The method of claim 10, further comprising outputting, by the meter electronics, diagnostic information when the vibrations at non-drive-mode frequencies detected are less than or equal to a predetermined proximity to the drive mode frequency and whether a separation between non-drive-mode frequencies and the drive mode frequencies remains stable or is varying, wherein if the separation between non-drive-mode frequencies and the drive mode frequencies remains stable, the diagnostic information comprises an instruction to calibrate a flowmeter zero.

13. The method of claim 10, further comprising outputting, by the meter electronics, diagnostic information when the vibrations at non-drive-mode frequencies detected are less than or equal to a predetermined proximity to the drive mode frequency and whether a separation between non-drive-mode frequencies and the drive mode frequencies remains stable or is varying, wherein if the separation between non-drive-mode frequencies and the drive mode frequencies is varying, the diagnostic information comprises an instruction to identify and eliminate a potential mounting and/or process condition change or changes that are responsible for frequency separation variability.

14. The method of claim 10, further comprising generating, by the meter electronics, at least one of an alarm and a notification when frequencies for a non-drive mode known to be associated with meter reliability issues is detected.

15. The method of claim 9, comprising coupling the at least one strain gage to at least one of the one or more flow tubes.

16. The method of claim 9, comprising coupling the at least one strain gage to a brace bar.
